(19) United States
(12) Patent Application Publication
(10) Pub. No.: US 2007/0069880 A1
(43) Pub. Date: Mar. 29, 2007

(54) Customizing the layout of the instrument panel of a motorized vehicle

(76) Inventors: Steven F. Best, Georgetown, TX (US); Michael R. Cooper, Austin, TX (US); James L. Gray, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/239,497

(22) Filed: Sep. 29, 2005

(51) Int. Cl. B60Q 1/00

(52) U.S. Cl. 340/461

(57) ABSTRACT

Methods, apparatus, and products are disclosed for customizing the layout of the instrument panel of a motorized vehicle, the method including creating a skin definition of the layout of the instrument panel of the motorized vehicle, installing the skin definition onto the motorized vehicle, and activating the skin definition as the layout of the instrument panel of the motorized vehicle.

### BACKGROUND OF THE INVENTION

1. Field of the Invention

The field of the invention is data processing, or, more specifically, methods, apparatuses, and products for customizing the layout of the instrument panel of a motorized vehicle, such as, for example, an automobile.

2. Description Of Related Art

Conventional dashboards for motorized vehicles, such as automobiles, provide consumers with little or no choice in the layout of the instrument panel. Furthermore, the original layout of the instrument panels cannot be changed without physically modifying the dashboard. The consumer has no opportunity to personalize or customize the layout of the instrument panel.

In contrast with the instrument panels of dashboards of motorized vehicles, user interfaces to many computer programs, whether the programs run on personal computers, over the web or on cell phones, are customizable through the use of skins.

A skin is a particular display of a customizable interface. Skins are created through specifications that define the overall appearance of the user interface. The specifications typically consist of a collection of images and a definition file of the objects constituting a user interface. The program which displays the user interface applies the specifications to display the user interface in accordance with the skins. Skins allow a user to express the user's personality through the layout, look and feel of the interface. Skins can often improve the ease of use and functionality of an interface. It would be advantageous to provide a method, apparatuses, and computer product for customizing the layout of the instrument panel of a motorized vehicle.

### SUMMARY OF THE INVENTION

Methods, apparatuses, and products are disclosed for customizing the layout of the instrument panel of a motorized vehicle, the method including selecting a skin definition of the layout of the instrument panel of the motorized vehicle, installing the skin definition onto the motorized vehicle, and activating the skin definition as the layout of the instrument panel of the motorized vehicle.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for customizing the layout of the instrument panel of a motorized vehicle according to embodiments of the present invention.

FIG. 2 sets forth a block diagram illustrating an exemplary system for customizing the layout of the instrument panel of an exemplary motorized vehicle according to embodiments of the present invention.

FIG. 3 sets forth a block diagram of automated computing machinery useful in customizing the layout of the instrument panel of a motorized vehicle according to embodiments of the present invention.

FIG. 4 sets forth a flow chart illustrating an exemplary method for customizing the layout of the instrument panel of a motorized vehicle according to embodiments of the present invention.

FIG. 5 sets forth a flow chart illustrating an exemplary method for receiving through a user interface specifications for the layout of the instrument panel of a motorized vehicle according to embodiments of the present invention.

FIG. 6 illustrates exemplary layouts of instrument panels of a motorized vehicle that may be created according to embodiments of the present invention.

FIG. 7 sets forth a flow chart illustrating an exemplary method for installing a skin definition onto a motorized vehicle according to embodiments of the present invention.

### DETAILED DESCRIPTION OF EXEMPLARY EMBODIMENTS

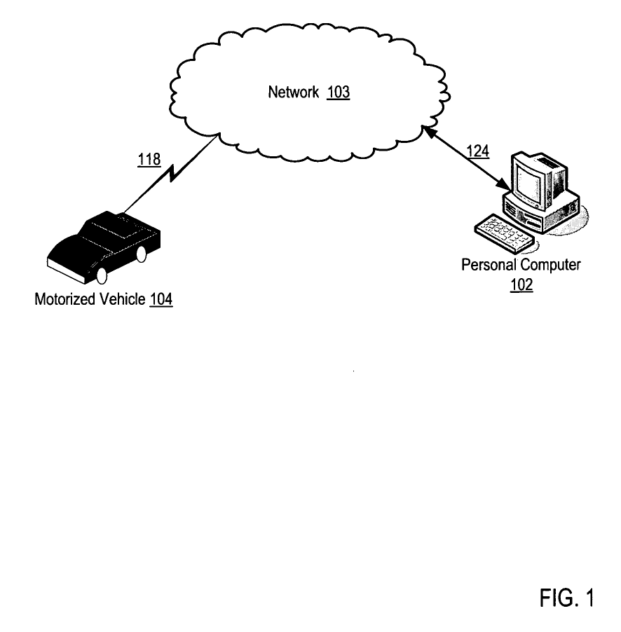

Exemplary methods, apparatuses, and products for customizing the layout of the instrument panel of a motorized vehicle according to embodiments of the present invention are described with reference to the accompanying drawings, beginning with FIG. 1. FIG. 1 sets forth a network diagram illustrating an exemplary system for customizing the layout of the instrument panel of a motorized vehicle according to embodiments of the present invention. The system of FIG. 1 includes an exemplary motorized vehicle (104), which in the example of FIG. 1 is an automobile (104).

The exemplary automobile (104) of FIG. 1 contains an instrument panel located on its dashboard. The exemplary automobile (104) is coupled to network (103) through wireless connection (118). The system of FIG. 1 operates generally to customize the layout of the instrument panel of the exemplary motorized vehicle (104) according to embodiments of the present invention by selecting a skin definition of the layout of the instrument panel of the motorized vehicle, installing the skin definition onto the motorized vehicle, and activating the skin definition as the layout of the instrument panel of the motorized vehicle.

The system of FIG. 1 includes a data communications network (103). Network (103) provides data communications between automobile (104) and computing devices having installed upon them computer program instructions for creating skin definitions of the layout of the instrument panel of a motorized vehicle and sending the skin definitions to the motorized vehicle over the network (103). In the example of FIG. 1, the computing device is personal computer (102), coupled to network (103) through wireline connection (124). A user operating software installed upon personal computer (102) is empowered to input specifications for the layout of the instrument panel of a motorized vehicle, such as, for example, an automobile, cause the specifications to be converted into a skin definition, and install the skin definition upon the motorized vehicle (104) by uploading the skin definition over the network to the motorized vehicle (104).

The arrangement of devices making up the exemplary system illustrated in FIG. 1 is for explanation, not for limitation. Network systems useful according to various embodiments of the present invention may include servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art.

Various embodiments of the present invention may be implemented on a variety of hardware platforms in addition to those illustrated in FIG. 1. Networks are not necessary in some embodiments of the present invention. A system for customizing the layout of the instrument panel of a motorized vehicle may be implemented upon a motorized vehicle not connected to any network. Furthermore, a user may install skin definitions for the layout of the instrument panel onto the motorized vehicle by porting the skin definition from another motorized vehicle or creating the skin definition using a device, such as the personal computer (102) of FIG. 1, and transferring the skin definition to the motorized vehicle through the use of a recordable medium.

While many of the examples described in this specification are directed toward automobiles, this is for explanation and not for limitation. In fact, embodiments of the present invention may be useful for customizing the layout of the instrument panel of any motorized vehicle. Examples of such motorized vehicle include automobiles, boats, helicopters, riding lawnmowers, tractors, or any other motorized vehicle that includes an instrument panel as will occur to those of skill in the art. All such motorized vehicles are well within the scope of the present invention.

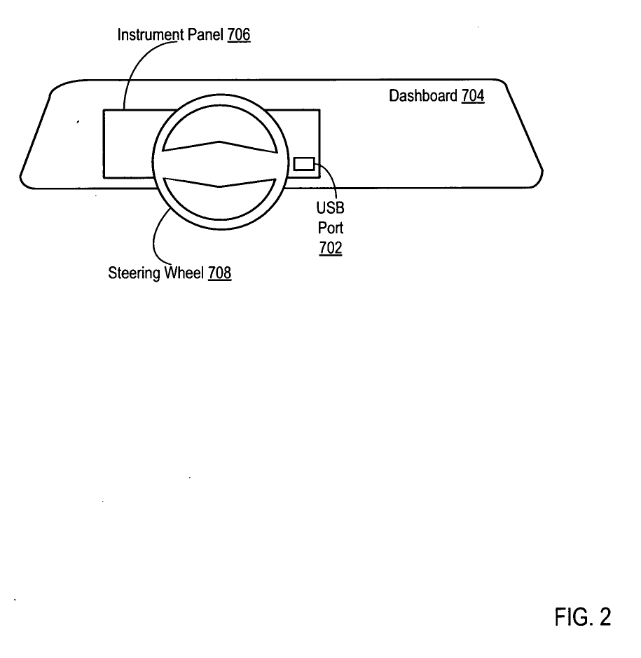

For further explanation, FIG. 2 sets forth a block diagram illustrating an exemplary dashboard (704) of a motorized vehicle having an instrument panel (706) that is customized according to embodiments of the present invention. The dashboard (704) of FIG. 2 includes an instrument panel (706), a steering wheel (708), and a USB port (702). The instrument panel (706) of FIG. 2 displays a plurality of instruments useful in operating the motorized vehicle such as for example a speedometer, a tachometer, an odometer, a clock, as well as other instruments useful in operating a motorized vehicle that will occur to those of skill in the art. The instrument panel (706) of FIG. 2 may be implemented as an addressable display device. An all points addressable display device is a display device that displays at each bit a color specified by a value in a bitmap. All points addressable displays include computer monitors, light-emitting diodes, liquid crystal displays, gas plasma displays, and other displays as will occur to those of skill in the art, and all such embodiments are well within the scope of the present invention. The layout of the instrument panel (706) of FIG. 2 is customizable according to embodiments of the present invention by creating a skin definition of the layout of the instrument panel of the motorized vehicle, installing the skin definition onto the motorized vehicle, and activating the skin definition as the layout of the instrument panel of the motorized vehicle.

In the example of FIG. 2, dashboard (704) includes a USB port (702). The USB port (702) may be used to install skin definitions upon the motorized vehicle useful in for customizing the layout of the instrument panel, or to store onto a recordable storage medium, such as a USB keydrive, a skin definition for porting the skin definition to another dashboard.

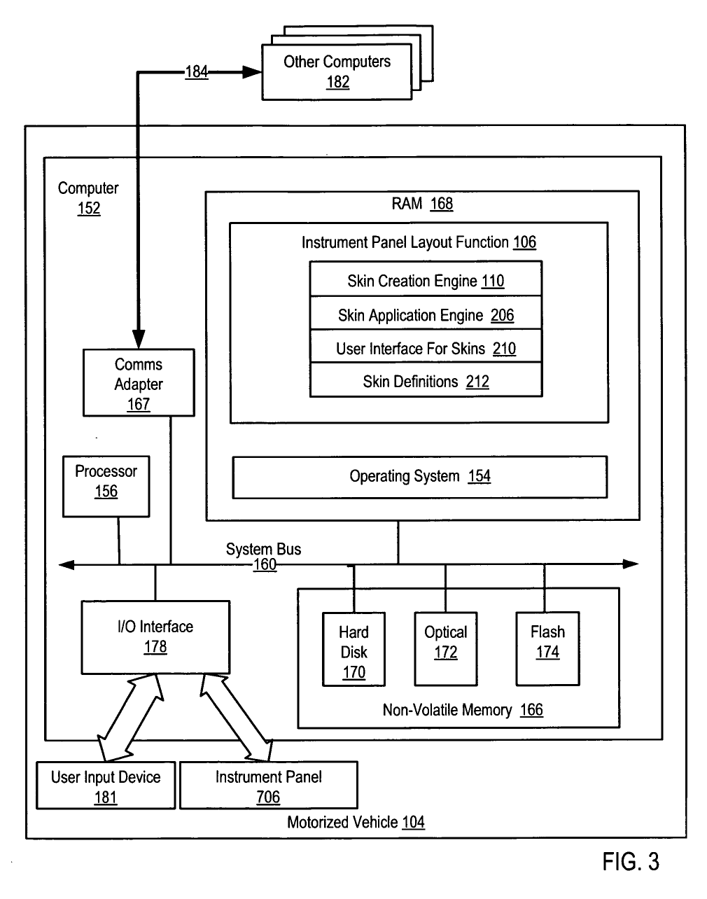

Customizing the layout of the instrument panel of a motorized vehicle in accordance with the present invention is generally implemented with computers, that is, with automated computing machinery. For further explanation, therefore, FIG. 3 sets forth a block diagram of automated computing machinery comprising an exemplary computer (152) useful in customizing the layout of the instrument panel of a motorized vehicle according to embodiments of the present invention. The computer (152) of FIG. 3 is contained in a motorized vehicle (104). The computer (152) of FIG. 3 includes at least one computer processor (156) or ‘CPU’ as well as random access memory (168) (‘RAM’) which is connected through a system bus (160) to processor (156) and to other components of the computer.

Stored in RAM (168) is an instrument panel layout function (106), computer program instructions for selecting a skin definition of the layout of the instrument panel of the motorized vehicle, installing the skin definition onto the motorized vehicle, and activating the skin definition as the layout of the instrument panel of the motorized vehicle. The instrument panel layout function (106) also includes a skin creation engine (110), computer program instructions for creating skin definition files for the skins of a motorized vehicle instrument panel. The instrument panel layout function (106) also includes a skin application engine (206), computer program instructions for applying a skin definition to an instrument panel of a motorized vehicle. The instrument panel layout function (106) also includes a user interface for skins (210), computer program instructions for receiving specifications on the layout of the instrument panel of a motorized vehicle from a user and providing the specifications to the skin creation engine (110) for creating skin definition files for the skins of a motorized vehicle instrument panel. The example of FIG. 2 also includes skin definitions (212), the definitions of one or more layouts for the instrument panel of a motorized vehicle.

The inclusion of the skin creation engine (110) and user interface for skins (210) in computer (152) contained in automobile (104) is for explanation, not for limitation. In alternative embodiments, for example, skin definitions for the layout of the instrument panel of the motorized vehicle may be created by use of a computer outside the motorized vehicle and ported to the motorized vehicle.

Also stored in RAM (168) is an operating system (154). Operating systems useful in computers according to embodiments of the present invention include UNIX™, Linux™, Microsoft Windows XP™, AIX™, IBM's i5/OS™, and others as will occur to those of skill in the art. Operating system (154), instrument panel layout function (106) and its components, skin creation engine (110), skin application engine (206), user interface for skins (210), and skin definitions (212) in the example of FIG. 3 are shown in RAM (168), but many components of such software typically are stored in non-volatile memory (166) also.

Computer (152) of FIG. 3 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 3 includes one or more input/output interface adapters (178). Input/output interface adapters in computers implement user-oriented input/output through, for example, software drivers and computer hardware for controlling output to an instrument panel (706), as well as user input from user input devices (181) such as mice. The instrument panel (706) of FIG. 3 typically displays a plurality of instruments useful in operating a motorized vehicle such as for example a speedometer, a tachometer, an odometer, a clock, as well as other instruments useful in operating a motorized vehicle that will occur to those of skill in the art. The instrument panel (706) of FIG. 3 may be implemented as an addressable display device. An all points addressable display device is a display device that displays at each bit a color specified by a value in a bitmap. All points addressable displays include computer monitors, light-emitting diodes, liquid crystal displays, gas plasma displays, and other displays as will occur to those of skill in the art, and all such embodiments are well within the scope of the present invention. The layout of the instrument panel (706) of FIG. 3 is customizable according to embodiments of the present invention by creating a skin definition of the layout of the instrument panel of the motorized vehicle, installing the skin definition onto the motorized vehicle, and activating the skin definition as the layout of the instrument panel of the motorized vehicle.

The exemplary computer (152) of FIG. 3 includes a communications adapter (167) for implementing data communications (184) with other computers (182). Such data communications may be carried out serially through RS-232 connections, through external buses such as USB, through data communications networks such as IP networks, Bluetooth networks, and in other ways as will occur to those of skill in the art. Communications adapters implement the hardware level of data communications through which one computer sends data communications to another computer, directly or through a network. Examples of communications adapters useful for customizing the layout of the instrument panel of a motorized vehicle according to embodiments of the present invention include modems for wired dial-up communications, Ethernet (IEEE 802.3) adapters for wired network communications, and 802.11b adapters for wireless network communications.

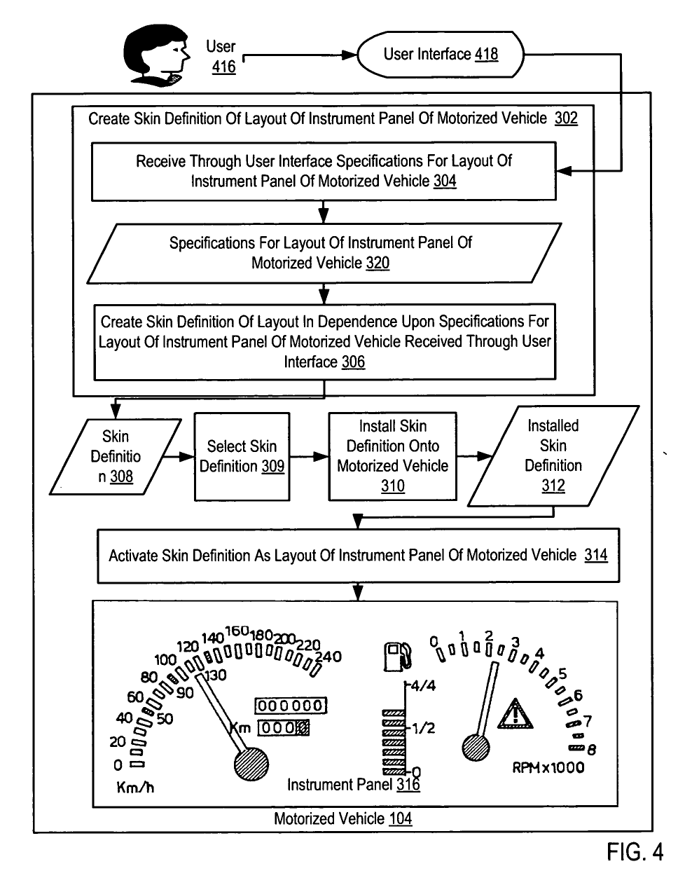

For further explanation, FIG. 4 sets forth a flow chart illustrating an exemplary method for customizing the layout of the instrument panel of a motorized vehicle according to embodiments of the present invention. The method of FIG. 4 includes creating (302) a skin definition (308) of the layout of the instrument panel of the motorized vehicle (104). A skin definition of a user interface is a specification of a skin or the overall layout of the user interface in a format understandable by a program which displays a user interface. Such skin definitions may specify the number, arrangement, function, and appearance of objects in the user interface and the appearance of the background. Skin definitions often consist of two parts. One part of a skin definition often consists of bitmap files of the various features of the skin, including the background and the objects comprising the layout. The second part of a skin definition often specifies the properties of objects which appear in the user interface.

For further explanation, the following pseudocode represents a skin definition for the layout of the instrument panel of an exemplary automobile:

```
SkinFile {
    View {
        backgroundImage {“background.bmp”}
        titleBar {“false”}
        }
    instrumentGroup {
        speedometer {10 10 10 10 APmN “BM1.bmp” “BM2.bmp”
        “BM3.bmp”}
        tachometer {10 30 10 10 DW “BM10.bmp”}
        odometer {30 10 5 5 “BM4.bmp”}
        tripOdometer {30 5 5 5 “BM4.bmp”}
        engineTemperature {40 5 5 5 ASFW “BM5.bmp” “BM6.bmp”}
        fuelGauge {40 20 8 8 PW “BM7.bmp” “BM8.bmp”
        “BM8.bmp”}
            }
        }
```

The above pseudocode represents a description of a layout for the instrument panel of an automobile. This example is described as ‘pseudocode’ because it is an explanation presented in the general form of a skin definition rather than an actual working model of a skin definition.

The exemplary skin definition above includes an element “SkinFile” that identifies the example above as a skin definition file to the processor which implements the skin. The exemplary skin definition above also includes a sub-element “View” that defines the background of the layout of the skin. Included in the view is a field “BackgroundImage”, which contains a pointer to a bitmap with the image to be used in the background of the instrument panel. In the above example, the pointer is in the form of the name of a file containing a bitmap. Also included in the view is a field “TitleBar,” which represents a caption for the instrument panel. In the above example, the field “false” indicates the absence of such a caption.

The exemplary skin definition above includes an element “instrumentGroup” that defines the instruments to be displayed on the instrument panel as a group. Several groups may comprise the instrument panel. The instruments include a speedometer, tachometer, odometer, trip odometer, engine temperature gauge, and fuel gauge. Instruments not included in the above pseudocode but which might appear in skin definitions of the layout of the instrument panel of the automobile include a display warning that a door is open or a seat belt is not fastened, temperature controls, audio controls, and other instruments that may occur to those of skill in the art. Each instrument may have a separate format for indicating the instrument's display properties.

The exemplary skin definition above includes an element “speedometer” representing a speedometer having its properties defined in parameters following the element. The speedometer is defined by the following parameters: 10 10 10 10 APmN “BM1.bmp” “BM2.bmp” “BM3.bmp.” The first two numbers, “10, 10” of the parameters defining the speedometer indicate the x and y coordinates of the instrument panel for locating the center of the speedometer. The next two numbers, “10, 10” of the parameters defining the speedometer indicate the height and width of the speedometer. The next four characters, “APmN,” of the the parameters defining the speedometer each indicate a property of the display of the speedometer. The A indicates that the display for the speedometer is to look like an analog speedometer, that is, a gauge, rather than digital-looking display. The P indicates the gauge has a pointer. The m indicates that the speedometer will display miles per hour, rather than kilometers per hour. The N indicates that the display will not provide an additional warning to the driver related to the instrument, such as flashing lights if the speed exceeds a certain amount. The last three fields, “BM1.bmp” “BM2.bmp” “BM3.bmp,” of the parameters defining the speedometer name three bitmap files containing bitmaps used for the display of components of the speedometer. The first bitmap file, “BM1.bmp,” specifies the appearance for the border of the speedometer, the second bitmap file, “BM2.bmp,” specifies the appearance for the interior of the speedometer, and the third bitmap file, “BM3.bmp,” specifies the appearance for the pointer of the speedometer.

The exemplary skin definition above also includes an element “tachometer” representing a tachometer having its properties defined in parameters following the element. The tachometer is defined by the following parameters: 10 30 10 10 DW “BM10.bmp. The first two numbers, “10, 30” of the parameters defining the tachometer indicate the x and y coordinates of the instrument panel for locating the center of the tachometer. The next two numbers, “10, 10” of the parameters defining the tachometer indicate the height and width of the tachometer. The next characters, “DW,” of the parameters defining the appearance of the tachometer each indicate a property of the display of the tachometer. The D indicates a digital display for the value of the tachometer. The value will be displayed as a number, rather than as a display of an analog-looking gauge. The W indicates that the instrument panel is to provide an additional warning if the indicator exceeds a certain value. The warning may be sound or flashing lights or other methods as will occur to one of skill in the art. The last field names a bitmap file, “BM10.bmp” which specifies the appearance for the border of the tachometer.

The exemplary skin definition above also includes an element “odometer” representing an odometer having its properties defined in parameters following the element. The odometer is defined by the following parameters: 30 10 5 5 “BM4.bmp.” The first two numbers, “30, 10” of the parameters defining the odometer indicate the x and y coordinates of the instrument panel for locating the center of the odometer. The next two numbers, “5, 5” of the parameters defining the odometer indicate the height and width of the odometer.

Unlike the case with the previous instruments, the fields for the display properties of the odometer do not include character fields representing choices of display. The odometer in the pseudocode example may, for instance, always have a digital display with no warning. The last field in the example above names a bitmap field, “BM4.bmp.” which specifies the appearance for the border of the odometer.

The exemplary skin definition above also includes an element “tripOdometer” representing a trip odometer having its properties defined in parameters following the element. The trip odometer is defined by the following parameters: 30 5 5 5 “BM4.bmp.” The first two numbers, “30, 5” of the parameters defining the trip odometer indicate the x and y coordinates of the instrument panel for locating the center of the trip odometer. The next two numbers, “5, 5” of the parameters defining the trip odometer indicate the height and width of the trip odometer. The last field in the example above names a bitmap field, “BM4.bmp.” which specifies the appearance for the border of the trip odometer.

The exemplary skin definition above also includes an element “engineTemperature” representing an engine temperature gauge having its properties defined in parameters following the element. The engine temperature gauge is defined by the following parameters: 40, 5 5 5 AFW “BM5.bmp” “BM6.bmp.” The first two numbers, “40, 5” of the parameters defining the engine temperature gauge indicate the x and y coordinates of the instrument panel for locating the center of the engine temperature gauge. The next two numbers, “5, 5” of the parameters defining the engine temperature gauge indicate the height and width of the engine temperature gauge. The next characters, “AFW,” of the parameters defining the appearance of the engine temperature gauge each indicate a property of the display of the engine temperature gauge. The letter A indicates an analog-looking display of the engine temperature gauge. The F indicates the scale is Fahrenheit. The W indicates the display is to issue a warning if the temperature exceeds a certain threshold value. The two bitmap files in the last two fields, “BM5.bmp” “BM6.bmp,” specify the appearance of the border and interior of the engine temperature indicator, respectively.

The exemplary skin definition above also includes an element “fuelGauge” representing a fuel gauge having its properties defined in parameters following the element. The fuel gauge is defined by the following parameters: 40 20 8 8 PW “BM7.bmp” “BM8.bmp” “BM8.bmp.” The first two numbers, “40, 20” of the parameters defining the fuel gauge indicate the x and y coordinates of the instrument panel for locating the center of the fuel gauge. The next two numbers, “8, 8” of the parameters defining the fuel gauge indicate the height and width of the fuel gauge. The next characters, “PW,” of the parameters defining the appearance of the fuel gauge and each letter indicates a property of the display of the engine temperature gauge. P indicates that a pointer is defined for specifying the value of the fuel gauge. The W indicates the display is to issue a warning if the temperature exceeds a certain threshold value. The three bitmap files, “BM7.bmp” “BM8.bmp” “BM8.bmp” specify the appearance of the border, interior and pointer of the fuel indicator, respectively.

In the method of FIG. 4, creating (302) a skin definition (308) of the layout of the instrument panel of the motorized vehicle (104) includes receiving (304), through a user interface (418), specifications (320) for the layout of the instrument panel of the motorized vehicle and creating (306) the skin definition (308) of the layout in dependence upon the specifications (320) received through the user interface (418). Receiving (304) through a user interface (418) specifications (320) for the layout of the instrument panel of the motorized vehicle may be carried out by receiving specifications (320) for the layout of the instrument panel of the motorized vehicle through a user interface (418) that is a component of the motorized vehicle (104). Alternatively, receiving (304) through a user interface (418) specifications (320) for the layout of the instrument panel of the motorized vehicle may be carried out by receiving specifications (320) for the layout of the instrument panel of the motorized vehicle through a user interface installed on a computer that is not component of the motorized vehicle. The user interface, for example, may consist of a standard user interface on a personal computer, including a mouse, keyboard, monitor and so on.

Receiving (304) through a user interface (418) specifications (320) for the layout of the instrument panel of the motorized vehicle (104) may be carried out by presenting images of an instrument panel to the user for selection with a pointing device, by a touch pad, or by other methods as will occur to those of skill in the art and receiving a selection of one or more instruments for display and receiving from the user parameters for displaying those selected instruments. Alternatively, receiving (304) through a user interface (418) specifications (320) for the layout of the instrument panel of the motorized vehicle may be carried out through the user of a wizard programmed to present to the user a series of screens of text offering the user a choice of features for the layout of the instrument panel and receiving from the user specifications for the layout of the instrument panel of the motorized vehicle, and in other ways as will occur to those of skill in the art.

In the method of FIG. 4, the specifications (320) received through the user interface may define the instruments to appear on the instrument panel, the sizes, shapes, colors, and locations of those instruments and other parameters of the display of the instruments as will occur to those of skill in the art. The display of certain instruments, such as a speedometer for example, may be mandatory. That is, the user may have a choice of whether other non-required instruments, such as radio settings or battery charge, appear in the instrument panel but may not have a choice or have limited choices for mandatory instruments. The specifications (320) received through the user interface may define the display of warning conditions and other information which only appears intermittently. As well as describing the instruments, the specifications received through the user interface may also describe the background of the instrument panel.

The method of FIG. 4 also includes creating (306) the skin definition (308) of the layout in dependence upon the specifications (320) for the layout of the instrument panel of the motorized vehicle received through the user interface. Creating the skin definition may be carried out by receiving the user specifications for the layout of the instrument panel of the motorized vehicle and creating in accordance with the specifications a bitmap file and a code file describing the instruments and their features. Such a bitmap file and code file may be useful in creating a single bitmap file defining the skin. Creating a skin definition of the layout of the instrument panel of a motorized vehicle may also be carried out by editing an existing skin definition file in code form, by coding a skin definition file in a language for coding skin definitions of instrument panels of automobiles, by using a graphics program to create the image of the layout of the instrument panel of the motorized vehicle, by combining images with computer program instructions specifying the functions of the instruments of the instrument panel of a motorized vehicle, and in other ways as will occur to those of skill in the art.

The method of FIG. 4 also includes selecting (309) a skin definition of the layout of the instrument panel of the motorized vehicle. Selecting (309) a skin definition of the layout of the instrument panel of the motorized vehicle may be carried out by selecting one of a plurality of skin definitions for the instrument panel in dependence upon the motorized vehicle type, user preferences, and other factors as will occur to those of skill in the art.

The method of FIG. 4 also includes installing (310) the skin definition (308) onto the motorized vehicle (104). Installing (310) the skin definition (308) onto the motorized vehicle (104) can be carried out by storing the skin definition (308) in the memory of a computing device of the motorized vehicle (152 in FIG. 3) that implements the display of the layout of the instrument panel of the motorized vehicle. Installing (310) the skin definition (308) onto the motorized vehicle (104) may be carried out by receiving a skin definition (308) over a network and storing the skin definition (308) in memory on the motorized vehicle. Installing (310) the skin definition (308) onto the motorized vehicle (104) may also be carried out by receiving the skin definition from a recordable medium, such as, for example, a USB keydrive, compact disc, or floppy disk, and storing the skin definition (308) in memory on the motorized vehicle.

The method of FIG. 4 also includes activating (314) the skin definition (312) as the layout of the instrument panel (316) of the motorized vehicle (104). Activating (314) the skin definition (312) as the layout of the instrument panel (316) of the motorized vehicle may be carried out by selecting the skin definition (312) as the skin definition used by a skin application engine (206 in FIG. 3) to produce the display of the instrument panel of the motorized vehicle. Activating (314) the skin definition (312) advantageously results in a customized layout of an instrument panel.

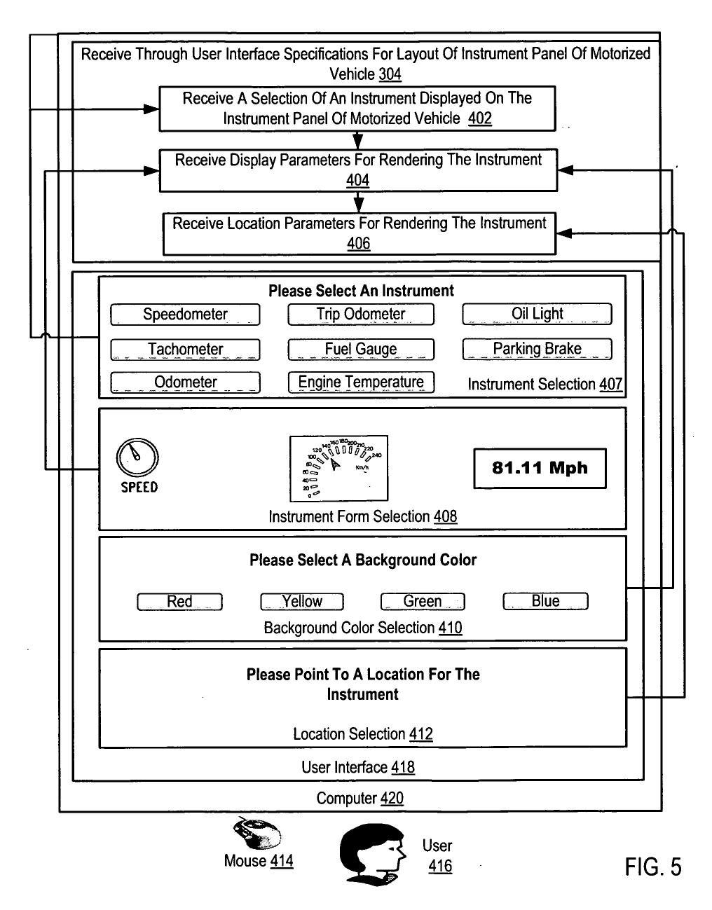

For further explanation, FIG. 5 sets forth a flow chart illustrating an exemplary method for receiving (304) through a user interface (418) specifications for the layout of the instrument panel of the motorized vehicle according to embodiments of the present invention. The method of FIG. 5 includes receiving (402) a selection of an instrument displayed on the instrument panel of a motorized vehicle. Receiving a selection of an instrument displayed on the instrument panel of a motorized vehicle may be carried out by presenting a list of instruments (407) to a user (416) and receiving the user's selection of an instrument from the list of instruments (407). In the example of FIG. 5, a user interface (418) displays the names of the instruments or images of the instruments for the user's selection.

The method of FIG. 5 also includes receiving (404) display parameters for rendering the instrument. Receiving the display parameters may be carried out by presenting a user with choices for rendering an instrument and generating display parameters in dependence upon the received choice of the user (416). In the example of FIG. 5, a user is presented with two display parameters selection screens, an instrument form selection screen (408) and a background color selection screen (410). The instrument form selection screen (408) in the example of FIG. 5 presents to the user (416) for selection three complete forms for the display of a speedometer. The first two forms from the left are analog forms. The first form has a circular boundary, a label at the bottom of the form, and a pointer which extends to the center of the form. The second form has a rectangular boundary, a series of bars extending from the numbers representing the speed, and a short pointer. The third form is digital and displays the speed to the nearest hundredth of a mile per hour. The examples of FIG. 5 are for explanation and not for limitation. Display parameters for rendering the instrument may include definitions for sub-components of an instrument such as an arrow or other pointer which points to the value of a gauge, the shading of a portion of the instrument to indicate the value, the form of the border of the instrument, and size and shape of the instrument, and the background color of the instrument.

The background color selection screen (410) in the example of FIG. 5 presents to the user (416) for selection four choices of background color. The choices in the example of FIG. 5 include red, yellow, green, and blue. The exemplary background colors are for explanation and not for limitation. In fact, instrument panels may be customized in accordance with the present invention with any background color as will occur to those of skill in the art.

The method of FIG. 5 also includes receiving (406) location parameters for rendering the instrument. Receiving (406) location parameters for rendering the instrument can be carried out by allowing the user to point to a desired location with a pointing device such as a mouse (414). In the example of FIG. 5, a user is presented with a location selection screen (412). The location selection screen of FIG. 5 empowers a user to point to a section of an instrument panel for the location of the instrument.

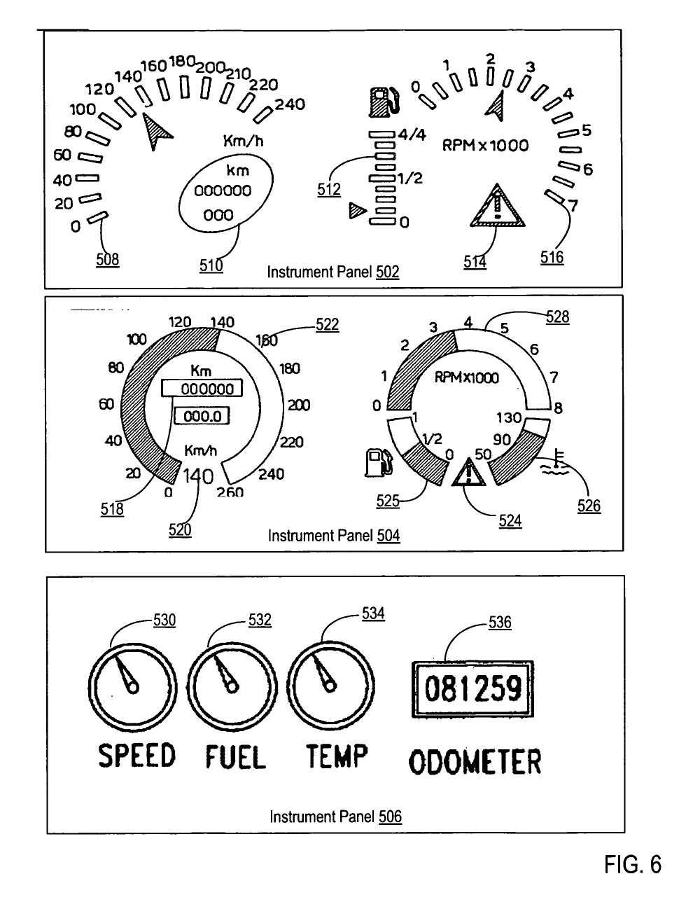

For further explanation, FIG. 6 illustrates three different customized layouts of instrument panels of a motorized vehicle according to embodiments of the present invention. Instrument panel (502) contains a speedometer (508), odometer and trip odometer (510), fuel gauge (512), engine temperature indicator (514), and tachometer (516). The speedometer (508) is presented in an analog gauge form. A small arrow points to bars which extend from numbers. A text label indicates that the units are Km/h. The odometer and trip odometer (510) are on the lower right of the speedometer. The display of the odometer and trip odometer consists of two numbers labeled with the units, km, contained within an oval border.

Instrument panel (502) also includes a fuel gauge (512). The fuel gauge (512) consists of bars stacked vertically and labeled with the fraction of the tank containing fuel. A small arrow points to the bar representing the current amount of fuel in the fuel tank of the motorized vehicle. A fuel pump icon appears at the top of the bars.

Instrument panel (502) also includes an engine temperature indicator (514). The engine temperature indicator (514) is in the form of a triangular warning symbol, which illuminates when active and is not illuminated when inactive. Instrument panel (502) also includes a tachometer (516). Tachometer (516) is in analog form. A small arrow points to bars which extend from numbers. A text label indicates that the units are in 1000's of revolutions per minute (‘RPMs’).

The example of FIG. 6 also includes another instrument panel (504) that contains a speedometer (522), odometer and trip odometer (518), fuel gauge (525), engine temperature indicator (524 and 526), and tachometer (528). The speedometer (508) is in analog gauge form and the value of the speedometer is represented by shading. The shading begins at 0 and continues to the value of the indicator, which is 140 Km/h in the current example. The display of the speedometer (508) also includes the value of the indicator in digital form, the 140 displayed at the bottom of the speedometer (508) corresponds to the value indicated by shading the speedometer. The units of the speedometer are labeled as Km/h. The odometer (518) and trip odometer consist of two numeric displays with separate rectangular borders.

Instrument panel (504) also includes a fuel gauge (525) which is displayed as a portion of a circle labeled by fractions. The value of the fuel gauge is indicated by shading. The fuel gauge display is labeled with the icon of a fuel pump. The instrument panel (504) also includes a tachometer (528). Tachometer (528) is displayed as a portion of a circle labeled with integers. The value of the tachometer is indicated by shading. The units of the tachometer are labeled as RPM×1000 or 1000's of revolutions per minute.

Instrument panel (504) also includes an engine temperature indicator (524 and 526). The engine temperature indicator consists of two parts, a warning (524) which illuminates when the temperature is too hot and a gauge (526) which indicates the actual temperature. Shading represents the value of the gauge (526). A thermometer icon labels the gauge.

The example of FIG. 6 also includes another instrument panel (506). The instrument panel (506) also contains a speedometer (530), fuel gauge (532), engine temperature indicator (534), and odometer (536). The first three instruments (530, 532, and 534) have identical form, a circular display with circular border and arrow extending from the center of the circle to the circumference to indicate the value of the indicator. Each instrument (530, 532, and 534) is labeled at the bottom by text. The odometer (536) of the instrument panel (506) is in digital form.

The three instrument panels (502, 504, and 506) illustrate the variety of layouts of the instrument panel of the motorized vehicle that may be achieved according to embodiments of the invention. The examples of FIG. 6 are for explanation and not for limitation. In fact, instrument panels according to embodiments of the present invention may include instruments that are analog-looking, digital-looking, have borders or are borderless, have a large pointer or a small pointer or no pointer at all, labels or no labels, icons or no icons, and any other feature, location, or attribute that will occur to those of skill in the art.

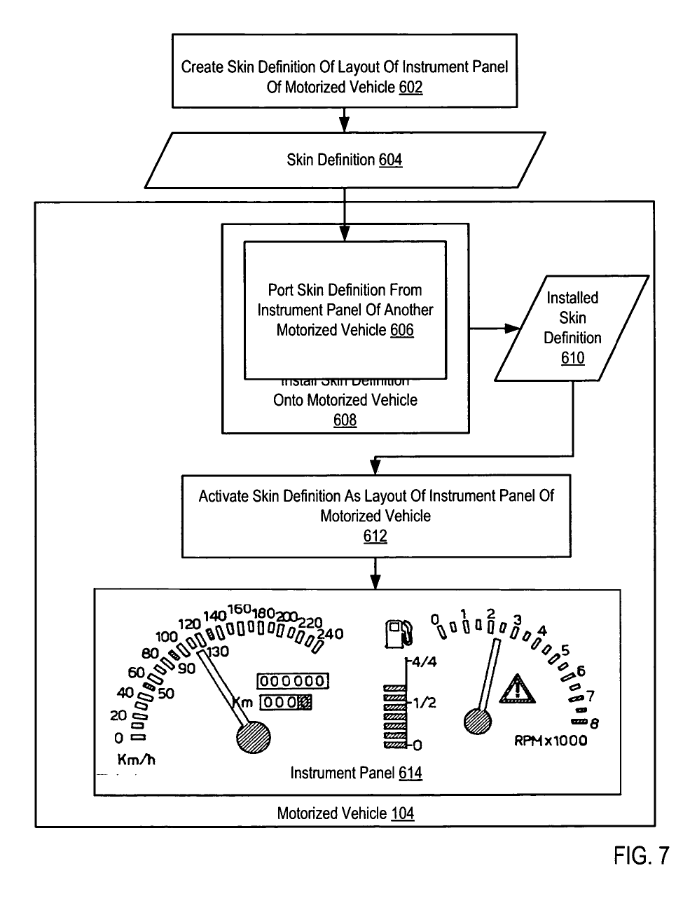

For further explanation, FIG. 7 sets forth a flow chart illustrating an exemplary method for customizing the layout of the instrument panel of a motorized vehicle according to embodiments of the present invention in which installing (608) the skin definition (604) onto the motorized vehicle (104) includes porting (606) the skin definition (604) from the instrument panel of another motorized vehicle. The method of FIG. 7 includes creating (602) a skin definition (604) of the layout of the instrument panel of the motorized vehicle (104). In the method of FIG. 7, the skin definition (604) of the layout of the instrument panel of the motorized vehicle (104) is created by creating the skin definition of the layout of the instrument panel of another motorized vehicle. Creating the skin definition (604) of the layout of the instrument panel of the other automobile may be carried out by receiving through a user interface specifications for the layout of the instrument panel of the other automobile and creating the skin definition of the layout in dependence upon the specifications for the layout of the instrument panel of the vehicle received through the user interface as discussed above. A skin definition may be named to distinguish it from others, and multiple skin definitions may exist to allow users to activate particular skin definitions as needed.

The method of FIG. 7 also includes installing (608) the skin definition (604) onto the motorized vehicle (104) by porting (606) the skin definition (604) from another motorized vehicle and storing the skin definition (604) in the memory of a computing device (152 in FIG. 3) that implements the display of the layout of the instrument panel of the motorized vehicle. Porting (606) the skin definition (604) from another motorized vehicle may be carried out by transferring directly the skin definition from one motorized vehicle to another through a network, by storing the skin definition on a recording medium for transfer between the motorized vehicles, or any other way of porting the skin definition that will occur to those of skill in the art.

Porting (606) the skin definition (604) from one motorized vehicle to another does not require the motorized vehicles to be of the same type. That is, the skin definitions from one type of motorized vehicle, such as a boat, may be ported to another type of motorized vehicle, such as an automobile. Porting skin definitions provides a vehicle for users to have consistent instrument panel layouts not only across motorized vehicles of the same type but also across disparate motorized vehicles.

The method of FIG. 7 also includes activating (612) the skin definition (610) as the layout of the instrument panel (614) of the motorized vehicle (104). Activating (612) the skin definition (610) as the layout of the instrument panel (614) of the motorized vehicle may be carried out by selecting skin definition (604) as the skin definition used by skin application engine (206 in FIG. 3) to produce the display of the instrument panel of the motorized vehicle. Activating (612) the skin definition (610) advantageously results in a customized layout of an instrument panel.

It is apparent to readers of skill in the art in view of the preceding explanation that the advantages of customizing the layout of the instrument panel according to embodiments of the present invention enables a driver of a motorized vehicle to create a customized layout of the instrument panel of the motorized vehicle that suits the driver's taste and that displays the information desired by the driver in an easy to understand manner that does not distract the driver from the operation of the motorized vehicle.

Exemplary embodiments of the present invention are described largely in the context of a fully functional computer system for customizing the layout of the instrument panel of a motorized vehicle. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for customizing the layout of the instrument panel of a motorized vehicle, the method comprising:
selecting a skin definition of the layout of the instrument panel of the motorized vehicle;
installing the skin definition onto the motorized vehicle; and
activating the skin definition as the layout of the instrument panel of the motorized vehicle.

2. The method of claim 1 further comprising creating a skin definition of the layout of the instrument panel of the motorized vehicle.

3. The method of claim 2 wherein creating a skin definition of the layout of the instrument panel of the motorized vehicle further comprises:
receiving, through a user interface, specifications for the layout of the instrument panel of the motorized vehicle; and:
creating the skin definition of the layout in dependence upon the specifications for the layout of the instrument panel of the motorized vehicle received through the user interface.

4. The method of claim 3 wherein receiving, through a user interface, specifications for the layout of the instrument panel of the motorized vehicle further comprises:
receiving a selection of an instrument displayed on the instrument panel of a motorized vehicle;
receiving display parameters for rendering the instrument; and
receiving location parameters for rendering the instrument.

5. The method of claim 3, wherein the user interface further comprises a software module for receiving specifications for the layout of the instrument panel of the motorized vehicle

6. The method of claim 3, wherein the user interface further comprises a component of the motorized vehicle.

7. The method of claim 1 wherein installing the skin definition onto the motorized vehicle further comprises porting the skin definition from another motorized vehicle.

8. The method of claim 1 wherein the instrument panel comprises an all points addressable display device.

9. A apparatus for customizing the layout of the instrument panel of a motorized vehicle, the apparatus comprising:
a computer processor;
a computer memory operatively coupled to the computer processor, the computer memory having disposed within it computer program instructions capable of:
selecting a skin definition of the layout of the instrument panel of the motorized vehicle;
installing the skin definition onto the motorized vehicle; and
activating the skin definition as the layout of the instrument panel of the motorized vehicle.

10. The apparatus of claim 9 wherein the computer memory also has disposed within it computer program instructions capable of creating a skin definition of the layout of the instrument panel of the motorized vehicle.

11. The apparatus of claim 9 wherein the computer memory also has disposed within it computer program instructions capable of:
receiving, through a user interface specifications for the layout of the instrument panel of the motorized vehicle; and
creating the skin definition of the layout in dependence upon the specifications for the layout of the instrument panel of the motorized vehicle received through the user interface.

12. The apparatus of claim 11 wherein the computer memory also has disposed within it computer program instructions capable of:
receiving a selection of an instrument displayed on the instrument panel of a motorized vehicle;
receiving display parameters for rendering the instrument; and
receiving location parameters for rendering the instrument.

13. The apparatus of claim 11 wherein the user interface further comprises a software module for receiving specifications for the layout of the instrument panel of the motorized vehicle

14. The apparatus of claim 9 wherein the computer memory also has disposed within it computer program instructions capable of porting the skin definition from another motorized vehicle.

15. The apparatus of claim 9 wherein the instrument panel comprises an all points addressable display device.

16. A computer program product for customizing the layout of the instrument panel of a motorized vehicle, the computer program product disposed upon a signal bearing medium, the computer program product comprising:
computer program instructions for selecting a skin definition of the layout of the instrument panel of the motorized vehicle;
computer program instructions for installing the skin definition onto the motorized vehicle; and
computer program instructions for activating the skin definition as the layout of the instrument panel of the motorized vehicle.

17. The computer program product of claim 16 further comprising computer program instructions for creating a skin definition of the layout of the instrument panel of the motorized vehicle.

18. The computer program product of claim 16 wherein the signal bearing medium comprises a recordable medium.

19. The computer program product of claim 16 wherein the signal bearing medium comprises a transmission medium.

20. The computer program product of claim 16 wherein the computer program instructions for creating a skin definition of the layout of the instrument panel of the motorized vehicle further comprise:
computer program instructions for receiving specifications for the layout of the instrument panel of the motorized vehicle; and
computer program instructions for creating the skin definition of the layout in dependence upon the specifications for the layout of the instrument panel of the motorized vehicle.
